(19) United States
(12) Patent Application Publication
(10) Pub. No.: US 2024/0347961 A1
(43) Pub. Date: Oct. 17, 2024

(54) Housing Assembly for a Plug Connector and Method for Assembling a Plug Connector

(71) Applicant: Rosenberger Hochfrequenztechnik GmbH & Co.KG, Fridolfing (DE)

(72) Inventors: Florian Hohenadl, Fridolfing (DE); Michael Endlmair, Fridolfing (DE)

(21) Appl. No.: 18/608,470

(22) Filed: Mar. 18, 2024

(30) Foreign Application Priority Data
Mar. 24, 2023 (EP) 23 164 088.9

(51) Int. Cl. H01R 13/506; H01R 13/52

(52) U.S. Cl. CPC H01R 13/506; H01R 13/5205

(57) ABSTRACT

A housing assembly (2) for a plug connector (1), having a first housing part (5), to form a cable bushing (7) through which a cable (3) can be introduced into an interior (8) of the housing assembly, and a cable sealing element (12), in the cable bushing (7), for the cable (3). The housing assembly (2) further has a housing securing part (23) enclosing the first housing part (5) in the region of the cable bushing (7) in the region of the cable sealing element (12). The first housing part (5) and the housing securing part (23) are, in a preassembly state, connected in one piece to one another via a connecting web (33).

The invention relates to a housing assembly for a plug connector, having at least one first housing part in order to form a cable bushing through which a cable can be introduced into an interior of the housing assembly, as well as a cable sealing element, accommodated in the cable bushing, for the cable, according to the preamble of Claim 1.

The invention furthermore relates to a plug connector, in particular an electrical plug connector, having a housing assembly and at least one contact element which can be connected to a cable.

The invention also relates to a method for assembling a plug connector.

Various electrical plug connectors are known from electrical engineering. Electrical plug connectors serve, as will be known, to transmit electrical power and/or data signals to corresponding mating plug connectors. A plug connector can involve a plug, a PCB connector, a built-in plug, a bushing, a coupling or an adapter. The designation “plug connector” used in the context of the invention is representative of all variants.

Among other things, increased demands are placed on the impermeability of plug connectors, in particular in relation to the automotive industry and vehicles. Electrical plug connectors with cable sealing elements within the cable bushing of the plug connector housing are fundamentally known. By way of example, reference is made in this regard to U.S. Pat. No. 10,847,924 B2.

It has been shown that the impermeability of a plug connector equipped with a cable sealing element can be impaired in the case of certain mechanical loads such as, for example, a transverse pull on the cable. As a result of the transverse load which comes from the cable in the region of the cable bushing, the cable sealing element can detach from an inner wall of the plug connector housing and as a result enable the penetration of contaminants or liquids.

The production of a plug connector with adequate impermeability which satisfies all the necessary standards and requirements is thus extremely complex. This represents a conflict of objectives with a further key demand on plug connectors, in particular on plug connectors for the automotive industry, according to which it must be possible to produce these cost-effectively in large quantities.

In view of the known prior art, the object of the present invention lies in providing a housing assembly for a plug connector, with which particular high impermeability requirements can be satisfied, with preferably cost-effective production and ease of assembly.

The object on which the present invention is based is also to provide a plug connector, in particular an electrical plug connector, which satisfies particularly high impermeability requirements, with preferably cost-effective production and ease of assembly.

A further object of the invention is to provide an advantageous method for assembling an electrical plug connector which satisfies high impermeability requirements.

The object is achieved for the housing assembly with the features listed in Claim 1. In terms of the plug connector, the object is achieved by the features of Claim 14 and in relation to the method by Claim 15.

The dependent claims and the features described below relate to advantageous embodiments and variants of the invention.

There is provided a housing assembly for a plug connector, having at least one first housing part in order to form a cable bushing (in particular a cable outlet and/or a cable inlet) through which a cable can be introduced into an interior of the housing assembly.

The invention is suitable in particular for use with an electrical plug connector. This should nevertheless not be understood in a restrictive manner since use with an optical plug connector or another plug connector is in principle also possible.

The housing assembly preferably forms the plug connector housing of the plug connector and generally has at least one interior which is at least substantially enclosed by the housing assembly in its assembled state, and in which plug connector components of the plug connector can be accommodated and optionally fixed and connected to one another.

The at least one housing part can have an at least substantially tubular or sleeve-shaped portion in order to form the cable busing, with a generally at least in portions rectilinear profile along an intended feed or discharge direction for the cable (a curved or angled profile of the cable bushing can, however, also in principle be intended).

The at least one housing part which forms the cable bushing preferably has at least in portions an inner lateral surface which can serve to bear the cable sealing element cited below. The inner lateral surface can have a substantially planar profile, possibly, however, also have recesses and/or elevations, for example, annularly circumferential grooves or ribs, in order to fix the cable and/or the cable sealing element in the assembled state of the housing assembly in a form-fitting manner.

It should be mentioned at this point that the cable is preferably not part of the claimed housing assembly. Nevertheless, the assembled cable can optionally also be regarded as part of the housing assembly.

According to the invention, the housing assembly has a cable sealing element, accommodated in the cable bushing, for the cable.

The cable sealing element is able to seal off the cable bushing preferably from contaminants, liquids and/or moisture. Gas impermeability can also be provided. In particular, for this purpose, the cable sealing element can provide a seal between cable sheath and inner lateral surface of the housing part which forms the cable bushing.

The cable sealing element is preferably formed in one piece.

In particular, a cable sealing element which is completely closed or annular in the circumferential direction and which has a central opening for guiding the cable through can be provided.

The cable sealing element is preferably fixed inside the cable bushing, for example, in a form-fitting manner, force-fitting manner or by material connection. For example, the cable sealing element can also be injection-molded in the first housing part, another housing part and/or in the housing securing part cited below.

The cable sealing element can extend along the entire cable bushing, possibly, however, also only be arranged in a portion of the cable bushing. Several cable sealing elements arranged distributed consecutively along the feed direction for the cable can optionally also be provided, it should be mentioned at this point that the invention can also be suitable for use with a housing assembly or a plug connector to which several cables are supplied. The cable bushing can be correspondingly configured for this purpose, wherein several cable bushings can also be provided which open into the interior of the housing assembly (for example, arranged next to one another or parallel, but also starting from various directions or sides of the housing assembly).

The cable bushing can, for example, be formed to accommodate precisely one cable, precisely two cables, precisely three cables, precisely four cables, precisely five cables, precisely two cables or more cables. Each of the cables can be assigned to a separate cable sealing element (several cable sealing elements which are accommodated in the cable bushing can correspondingly be provided), wherein nevertheless several cables (for example, in each case two, three or all the cables) can also be guided through a joint cable sealing element, wherein the joint cable sealing element preferably has several adjacent openings for the respective guiding through of the individual cables.

The invention is described below substantially on the basis of a housing assembly or a plug connector with only one single cable. This is nevertheless only supposed to serve the purpose of improved understanding and should not be understood in a restrictive manner for the invention.

According to the invention, the housing assembly has a housing securing part which at least in portions encloses the housing parts (at least the first housing part and the second housing part) at least in the region of the cable bushing.

It can preferably be provided that the housing securing part is formed in the manner of terminal cap or end cap for the housing assembly. The housing securing part can enclose the housing part(s) preferably at least starting from the cable-side end of the cable bushing. It can also be provided that the housing securing part is formed to be annular or sleeve-shaped and has no face-side terminal surface or stop surface.

It can in particular be provided that the housing securing part encloses the first housing part (and/or the second housing part also cited below) at least in the region of the cable bushing in which the cable sealing element is arranged.

The housing securing part is able to advantageously increase the rigidity of the housing assembly in the region of the cable bushing. A mechanical load on the cable can be at least substantially absorbed by the housing securing part so that a detachment of the cable sealing element from the inner lateral surface of the housing part which forms the cable bushing can be avoided.

It has surprisingly been shown that the impermeability of the housing assembly can significantly improve by using the housing securing part.

It is provided according to the invention that at least the first housing part and the housing securing part are, in a preassembly state, connected in one piece to one another via at least one connecting web.

The connecting web preferably only has a very small thickness or a wall thickness which is smaller than the thinnest wall thickness of the housing parts and/or the housing securing part, for example, is smaller by a factor of 1.5, is smaller by a factor of 2 or is even smaller.

A one-part manufacture of the housing securing part with at least one of the housing parts can reduce the costs for the production of the housing assembly in particular if production is performed as a joint plastic injection-molded part.

In one advantageous further development of the invention, it can be provided that the connecting web is formed as a predetermined breaking point in order to separate the first housing part and the housing securing part prior to or during final assembly.

As a result of the breaking of the at least one connecting web or the predetermined breaking point, the individual components of the housing assembly can subsequently be treated as separate parts in a conventional manner during final assembly.

The at least one connecting web can in particular be formed to break as a result of an axial movement of the housing securing part in the direction of the cable bushing.

According to a further development of the invention, it can be provided that the connecting web is formed to be elastically deformable at least in portions, in particular in the manner of a film hinge, in order to enable the assembly of the housing securing part on the first housing part.

It can be provided that a defined relative movement (e.g. a rotational or pivoting movement) between the housing securing part and the at least one housing part is possible despite the connecting web.

In one advantageous further development of the invention, it can be provided that the housing securing part is, in the preassembly state, arranged rotated and/or pivoted with respect to a state assembled on the first housing part.

The housing securing part can also be connected to the housing part via the at least one connecting web in such a manner that it, in the unassembled state or preassembly state, in comparison with a state assembled on the housing part is spaced apart from the cable input along the securing assembly direction (for example, along the feed direction for the cable).

In a further development of the invention, it can be provided that the at least one connecting web is formed in the region of the cable bushing of the first housing part.

Precisely one connecting web can be provided. However, several of the connecting webs can also be provided. In so far as several connecting webs are provided, these can preferably be arranged distributed along the circumference of the cable bushing, for example, distributed at equidistant angle segments. The several connecting webs can nevertheless also be arranged parallel or next to one another, in particular in a joint plane, for example, to enable a bending or pivoting movement.

According to a further development of the invention, it can be provided that the housing assembly has a second housing part which can be connected mechanically to the first housing part.

The housing parts preferably form, in the state in which they are connected together, respective circumferential portions of the cable bushing, wherein the housing securing part at least in portions encloses the first housing part and the second housing part at least in the region of the cable bushing in order to fix housing parts on one another.

The undesirable detachment of the cable sealing element from an inner wall of the plug connector housing in the case of transverse forces acting on the cable is, according to experience, pronounced in particular in the case of a multi-part plug connector housing. In this case, the cable sealing element is often arranged between two housing parts which, as a result of play which is generally always present in practice, have a certain degree of mobility with respect to one another. The invention is therefore particularly advantageously (but not exclusively) suitable for a housing assembly in the case of which the cable bushing is formed by several housing parts. The housing securing part is thus preferably able to jointly enclose the first housing part and the second housing part in order to fix the housing parts on one another.

The housing securing part can advantageously join the housing parts to one another with as little play as possible in order to reduce the mobility between the housing parts and increase the rigidity of the housing assembly—in particular in the region of the cable bushing and particularly preferably in a portion of the cable bushing in which the cable sealing element is arranged.

In addition to the first housing part and the second housing part, in the context of the invention or the proposed housing assembly, further housing parts can also be provided, for example, a third housing part, a fourth housing part and even more housing parts. In so far as “the housing parts” are discussed below, this indication should be taken to refer at least to the first housing part and the second housing part, possibly, however, also further housing parts even if this is not explicitly indicated.

Multi-part plug connector housings or housing assemblies are regularly used in the case of angled plug connectors. The first housing part and the second housing part can therefore involve housing parts of an angled plug connector. At least one the housing parts can then correspondingly be formed to be angled—this is, however, not absolutely necessary.

The second housing part can, for example, form a housing base body of the plug connector and the first housing part can form a housing cover for the housing base body. Overall, the housing parts can preferably form an inner plug connector housing. The housing securing part mentioned below can then be mounted on this inner plug connector housing (it can therefore also be referred to as an “outer plug connector housing” or “terminal cap”).

Preferably, a first part of the circumferential portion of the cable bushing is formed by the first housing part and a second part of the circumferential portion of the cable bushing is formed by the second housing part. The housing parts, which together form the cable bushing, can optionally overlap at least in portions along the circumference of the cable bushing, although each of the housing parts is preferably assigned at least substantially to its own circumferential portion of the cable bushing. The cable busing is preferably at least substantially completely closed in the circumferential direction (for example, apart from any gaps in the transition between the housing parts).

According to a further development of the invention, it can be provided that a housing assembly direction for connecting the first housing part to the second housing part and a securing assembly direction for assembling the housing securing part on the housing parts differ from one another.

In particular, it can be provided that the housing assembly direction and the securing assembly direction run at an angle between 45° and 90° to one another, preferably orthogonally or at least substantially orthogonally to one another. In this way, assembly can be carried out particularly easily and gently, wherein the housing securing part can at the same time block unintentional disassembly of the housing parts.

It can possibly, however, also be provided that the housing assembly direction and the securing assembly direction run parallel or at least substantially parallel to one another, for example, at an angle of less than 45°. In this case, assembly can be carried out, for example, by temporarily spreading out a clamp-like housing securing part. In this case too, the housing securing part can then block unintentional dismantling of the housing parts.

In an advantageous further development of the invention, it can be provided that the housing securing part on at least one of the housing parts is displaceable (in particular along a feed direction for the cable or at least substantially along the feed direction for the cable, possibly, however, also along a direction which deviates from this).

The housing securing part can preferably be guided on the at least one housing part, in particular until the housing securing part reaches a final assembly position in which it fixes the housing parts. For example, it can be provided that the housing securing part and at least one of the housing parts form a mutual linear guide.

The assembly of the housing assembly can be simplified by the guide function and the susceptibility to errors (in particular the risk of damage to a component) can be reduced.

For example, the housing securing part can be guided linearly on an outer lateral surface of at least one of the housing parts, in that the housing securing part completely or partially surrounds or clasps the at least one housing part that forms the cable bushing.

Alternatively or additionally, for example, a rail guide system can also be provided, wherein the housing securing part has one or more elevations (e.g. webs, pins, sliding blocks, etc.) which are guided linearly in one or more corresponding recesses (e.g. grooves or folds) arranged running along the assembly direction for the housing securing part (hereinafter referred to as “securing assembly direction”). A reverse arrangement, in which the housing securing part has the depressions and the housing parts have the elevations, can also be provided (as well as mixed variants).

According to a further development of the invention, it can be provided that the housing securing part fully circumferentially, in particular annularly, encloses at least the first housing part in the region of the cable bushing.

In the case of a circumferentially closed housing securing part, the cable bushing can be mechanically reinforced or stiffened particularly effectively. This variant of the invention can therefore be particularly suitable if very high transverse forces on the cable are to be expected.

In a further development of the invention, however, it can also be provided that the housing securing part merely clasps around at least the first housing part in the region of the cable bushing.

In particular, it can be provided that the housing securing part has, for this purpose, at least one support surface with which it can be supported on a counter-support surface of the at least one housing part forming the cable bushing (i.e. on at least one of the outer lateral surfaces of the housing parts), as well as two side legs, which extend from the support surface along respective sides, which face away from one another, of the at least one housing part. Preferably, at least one of the side legs (particularly preferably both side legs) clasps the at least one housing part on the side facing away from the counter-support surface.

Alternatively or additionally, it can also be provided that at least one of the side legs (particularly preferably both side legs) has an elevation (e.g. a web or a pin) in one or more portions between the counter-support surface and the housing side opposite the counter-support surface, with which a fixation or clamping can take place within a side surface of the housing parts.

Advantageously, the clasping of the at least one housing part by the housing securing part can simultaneously be used as a linear guide, for example, a rail guide system.

In one configuration of the invention, it can be provided that the housing securing part can be captively connected in its assembled state to at least one of the housing parts (preferably to at least the first housing part and the second housing part).

In particular, it can be provided that the housing securing part can be locked, pressed or screwed to the first housing part and/or the second housing part. Locking is particularly preferred because it can be implemented using technically simple means and at the same time can also be easily assembled and disassembled. Accordingly, the housing securing part can have one or more locking elements and the housing parts can have corresponding counter-locking elements. The locking elements or counter-locking elements can be, for example, elastic or resilient locking arms, locking springs, locking projections (e.g. locking hooks), edges, locking receptacles (e.g. openings or recesses).

Preferably, in each case at least one locking element is arranged on at least two sides of the housing securing part, in particular on opposite sides or sides facing away from one another.

As already mentioned, a screw connection of the housing securing part to one of the housing parts can also be provided if necessary. This is particularly advantageous if at least the corresponding housing part is formed to be at least substantially rotationally symmetrical.

It can be provided that the first housing part and the second housing part are fastened to one another in a force-fitting, form-fitting and/or material-locking manner in their interconnected state.

In a particularly preferred configuration of the invention, it can be provided in particular that the first housing part and the second housing part can be locked together.

Locking is particularly preferred because it can be implemented using technically simple means and at the same time can also be easily assembled and disassembled. Accordingly, the first housing part can have one or more locking elements and the second housing part can have corresponding counter-locking elements. The locking elements or counter-locking elements can be, for example, elastic or resilient locking arms, locking springs, locking projections (e.g. locking hooks), edges, looking receptacles (e.g. openings or recesses).

In one advantageous configuration of the invention, it can be provided that the housing securing part is made of the same material as at least one of the housing parts.

Preferably, all housing parts of the housing assembly, in particular the first housing part and the second housing part, as well as the housing securing part are formed from the same material.

The housing parts (in particular the first housing part and the second housing part) and/or the housing securing part are preferably formed from a plastic, in particular a hard plastic, such as a thermoplastic or thermoset (preferably not an elastomer). However, the components can also be formed from a metal, a ceramic or another material. Combinations of multiple materials (within the same component or within the housing assembly) can also be provided. The housing assembly particularly preferably forms an electrically insulating connector housing. The housing assembly can, for example, however, also form an outer conductor assembly of the plug connector.

In one advantageous configuration of the invention, it can be provided that the housing parts, in their connected state, together form a housing assembly for an angled plug connector.

In particular, at least one of the housing parts can be formed to be angled.

In a further development of the invention, it can be provided that the housing assembly has a housing sealing element which is formed to ensure a seal between the first housing part and at least one further housing part, in particular the second housing part.

The housing sealing element is preferably formed in one piece.

It can be provided that the housing sealing element has a circumferentially closed or annular profile and forms a central opening.

In particular—but not exclusively—in the case of a housing assembly for an angled plug connector, it can be provided that the housing sealing element is formed in an angled manner, so that a first portion of the housing sealing element and the central opening extends in a first plane and a second portion of the housing sealing element and the central opening extends in a second plane.

The first plane and the second plane are preferably arranged at an angle between 45′ and 90° to one another, in particular aligned orthogonally or at least substantially orthogonally to one another. In principle, however, any angle can be provided between the first plane and the second plane.

The first portion of the housing sealing element preferably corresponds to a U-shaped or partially annular portion of the housing sealing element. The second portion of the housing sealing element preferably corresponds to a further U-shaped portion or annular portion of the housing sealing element.

A transition region can preferably be provided between the first portion and the second portion of the housing sealing element, in particular a transition region with a curved profile, in order to enable a material-friendly transition between the different orientations of the portions.

The first portion is preferably longer than the second portion, wherein the second portion of the housing sealing element is preferably arranged in the region of the cable bushing.

In one advantageous configuration of the invention, it can be provided that the housing sealing element is connected to one of the housing parts in a materially bonded manner.

The housing sealing element can, for example, be glued into one of the housing parts, in particular inject-molded in one of the housing parts. In this way, a captive delivery state can be ensured.

However, it can also be provided that the housing sealing element is connected to at least one of the housing parts in a force-fitting or form-fitting manner. In principle, a captive connection to one of the housing parts is not absolutely necessary when the housing assembly is unassembled—it may therefore be sufficient if the housing sealing element is only fixed by final assembly for the purpose of sealing between the housing parts.

The housing sealing element and/or the cable sealing element can have one or more, for example, two, three, four or even more sealing lips.

In one configuration of the invention, it can be provided that the cable sealing element and the housing sealing element are formed in one piece by a common sealing body.

In particular, it can be provided that the cable sealing element and the housing sealing element form respective portions of the common seal body. The production of a common sealing body can reduce manufacturing costs and also make assembly easier and more reliable.

The invention also relates to a plug connector, in particular an electrical plug connector, having a housing assembly according to the above and following embodiments and at least one contact element that can be connected to the cable (e.g, an inner conductor contact element or an outer conductor contact element).

By using the housing securing part, which can serve as an outer housing for at least the first housing part, at least in the region of the cable bushing of the plug connector, the mechanical properties of the housing assembly can be enhanced. In particular, the rigidity and transverse tensile strength in the region of the cable bushing can be increased because the wall thickness of the first housing part is increased and the first housing part can be fixed to the second housing part (if present). In the proposed manner, a particularly robust, waterproof plug connector, in particular a waterproof angled plug connector, can be provided.

The plug connector according to the invention can in principle have any desired plug connector components. For example, the plug connector can have various contact elements, a mechanical plug-in interface for connection to a mating plug connector, dielectrics, shielding means and other sealing elements.

As already mentioned, the plug connector can be an electrical plug connector (e.g. a shielded electrical plug connector or a coaxial plug connector or a differential plug connector), an optical plug connector or another plug connector. The invention is not to be understood as being limited to a specific variant.

The connector according to the invention can be used particularly advantageously within a vehicle, in particular a motor vehicle. Possible areas of application include autonomous driving, driver assistance systems, navigation systems, infotainment systems, rear-seat entertainment systems, Internet connections and wireless gigabit (IEEE 802.11 ad standard). Possible applications include high-resolution cameras, such as 4K and 8K cameras, sensors, onboard computers, high-resolution screens, high-resolution dashboards, 3D navigation devices and mobile devices.

It can also be used as a high-voltage connector. However, the plug connector according to the invention is suitable for any application within the entire electrical engineering sector and is not limited to use in vehicle technology.

The invention also relates to a method for assembling a plug connector, comprising at least the following method steps:
Providing a housing assembly which has at least one first housing part and a housing securing part which, in a preassembly state, are connected in one piece to one another via at least one connecting web;
Introducing a cable through a cable sealing element which is accommodated in a cable bushing formed by at least the first housing part; and
Final assembly of the housing securing part on at least the first housing part so that it is enclosed at least in portions at least in the region of the cable bushing by the housing securing part.
   wherein the at least one connecting web is broken during or prior to final assembly in order to separate the first housing part and the housing securing part.

It should be emphasized at this point that the method steps mentioned do not necessarily have to be carried out in the order in which they are first described or mentioned. For example, individual method steps or groups of method steps can be interchangeable with one another if this is not technically impossible. Method steps can also be combined with one another, divided into separate intermediate steps or supplemented with intermediate steps. The method is also not necessarily described conclusively with the method steps described and can be supplemented with further method steps that are not mentioned.

It can preferably be provided that the cable sealing element and/or the housing securing part are already pushed onto the cable before the cable is inserted into the cable bushing.

Features that have been described in connection with one of the subject matters of the invention, namely given by the housing assembly according to the invention, the plug connector according to the invention and the method according to the invention, can also be advantageously implemented for the other subject matters of the invention. Likewise, advantages that were mentioned in connection with one of the subject matters of the invention can also be understood in relation to the other subject matters of the invention.

In addition, it should be noted that terms such as “comprising”, “having” or “with” do not exclude any other features or steps. Furthermore, terms such as “a” or “the”, which refer to a singular number of steps or features, do not exclude a plurality of features or steps—and vice versa.

In a puristic embodiment of the invention, however, it can also be provided that the features introduced in the invention with the terms “comprising”, “having” or “with” are listed exhaustively. Accordingly, one or more lists of features may be considered as exhaustive within the scope of the invention, for example considered for each claim. The invention can, for example, consist exclusively of the features mentioned in Claim 1.

It should be mentioned that terms such as “first” or “second” etc. are used primarily for reasons of distinguishing between respective device or method features and are not necessarily intended to indicate that features are mutually dependent or related to one another.

Furthermore, it should be emphasized that the values and parameters described here include deviations or fluctuations of ±10% or less, preferably ±5% or less, more preferably ±1% or less, and very particularly preferably ±0.1% or less of the respectively named value or parameter, provided that these deviations are not excluded when implementing the invention in practice. The specification of ranges using start and end values also encompasses all those values and fractions that are included in the respectively known range, in particular the start and end values and a respective mean value.

The invention furthermore also relates to a housing sealing element that is independent of Claim 1 for a housing assembly of a plug connector, with the applicant reserving the right to claim this independent housing sealing element separately, as defined below. Said independent housing sealing element has a circumferentially completely closed profile and forms a central opening. The independent housing sealing element is characterized in that it is formed to be angled so that a first portion of the housing sealing element and the central opening extends in a first plane and a second portion of the housing sealing element and the central opening extends in a second plane. The features mentioned above and below, in particular those that relate to the housing sealing element of the housing assembly according to Claim 1, and very particularly the features of Claim 13, relate to advantageous embodiments and variants of the independent housing sealing element. In particular, the applicant also reserves the right to separately claim a housing part of a housing assembly which has the above-mentioned independent housing sealing element (in particular if the housing sealing element is inject-molded in the housing part), wherein the features of the first housing part and/or the second housing part described above and below are to be understood as advantageous embodiments and variants of the independent housing part. Finally, the applicant furthermore also reserves the right to separately claim a plug connector that has a housing assembly with a housing part mentioned above with the independent housing sealing element.

Exemplary embodiments of the invention are described in greater detail below on the basis of the drawings.

The figures show in each case preferred exemplary embodiments in which individual features of the present invention are represented in combination with one another. Features of an exemplary embodiment can also be implemented independently of the other features of the same exemplary embodiment and can correspondingly be readily combined by a person skilled in the art to form further expedient combinations and sub-combinations with features of other exemplary embodiments.

Functionally identical elements are provided with the same reference signs in the figures.

In each case schematically:

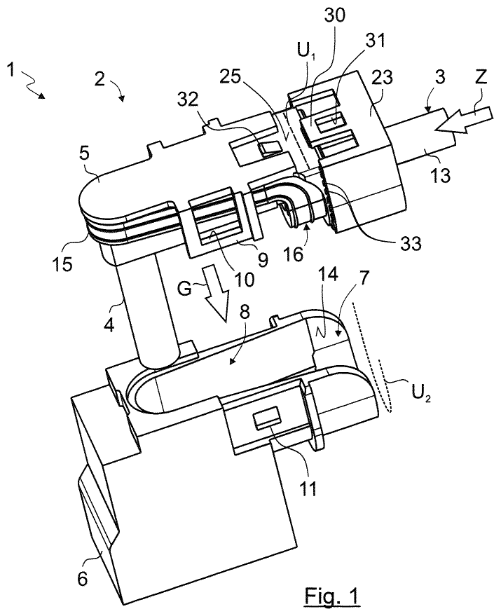

FIG. 1 shows a plug connector with a housing assembly according to one exemplary embodiment of the invention in a perspective representation, during a first assembly step;

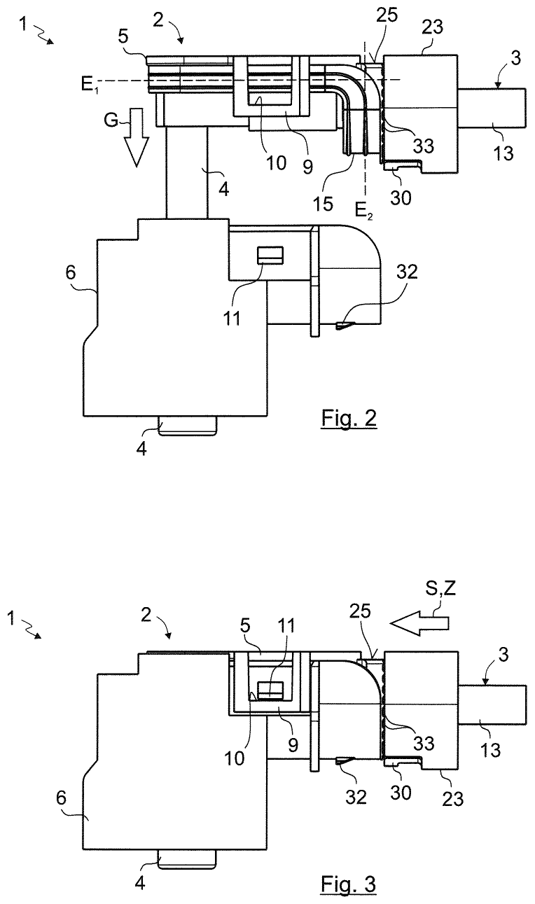

FIG. 2 shows the plug connector of FIG. 1 in a side view, during the first assembly step;

FIG. 3 shows the plug connector of FIG. 1 in a side view, during a second assembly step;

FIG. 4 shows the plug connector of FIG. 1 in a perspective representation, in a fully assembled state of the housing assembly;

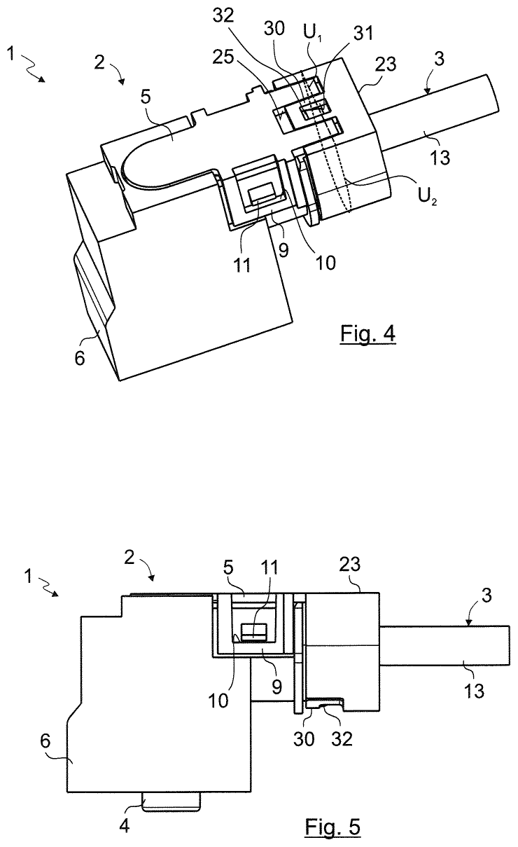

FIG. 5 shows the plug connector of FIG. 1 in a side view, in the fully assembled state of the housing assembly;

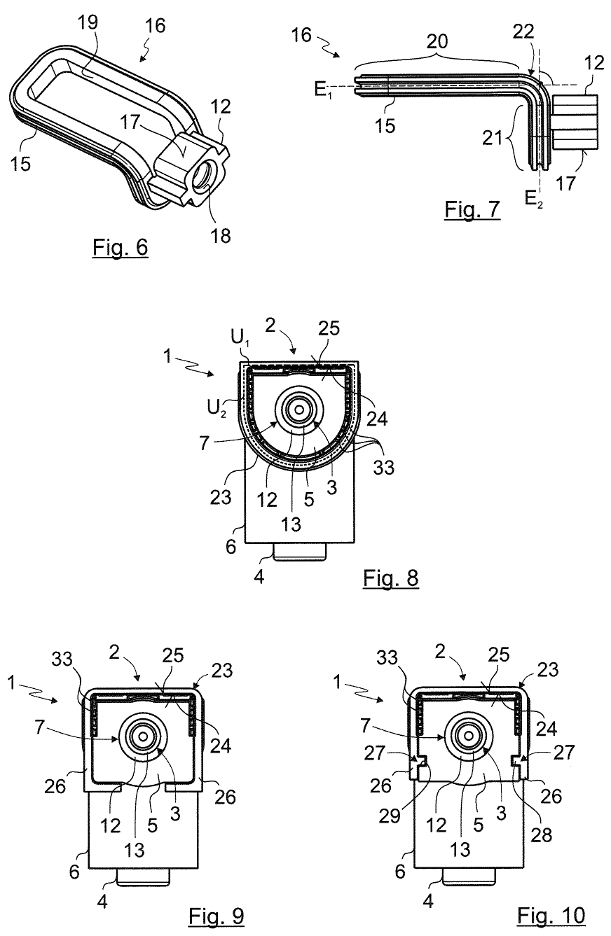

FIG. 6 shows a one-piece sealing body with a housing sealing element and a cable sealing element according to one exemplary embodiment in a perspective representation;

FIG. 7 shows the sealing body of FIG. 6 in a side view;

FIG. 8 shows a front view of the cable bushing of a fully assembled housing assembly according to a first variant, according to which the housing securing part fully circumferentially encloses the cable bushing;

FIG. 9 shows a front view of the cable bushing of a fully assembled housing assembly according to a second variant, according to which the housing securing part clutches the cable bushing;

FIG. 10 shows a front view of the cable bushing of a fully assembled housing assembly according to a third variant, according to which the housing securing part is in engagement with the cable bushing via a rail guide system;

FIG. 11 shows a plug connector with a housing assembly according to a further exemplary embodiment of the invention in a side view, during a first assembly step;

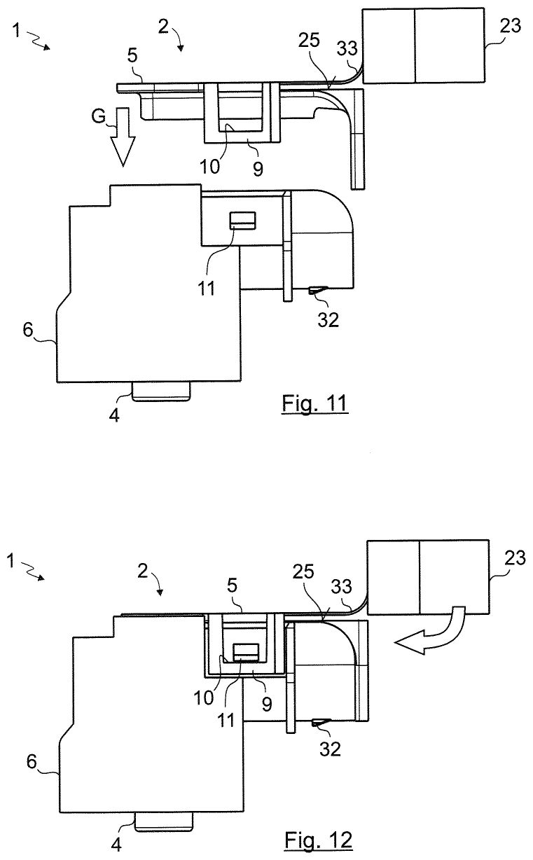

FIG. 12 shows the plug connector of FIG. 11 in a side view, during a second assembly step;

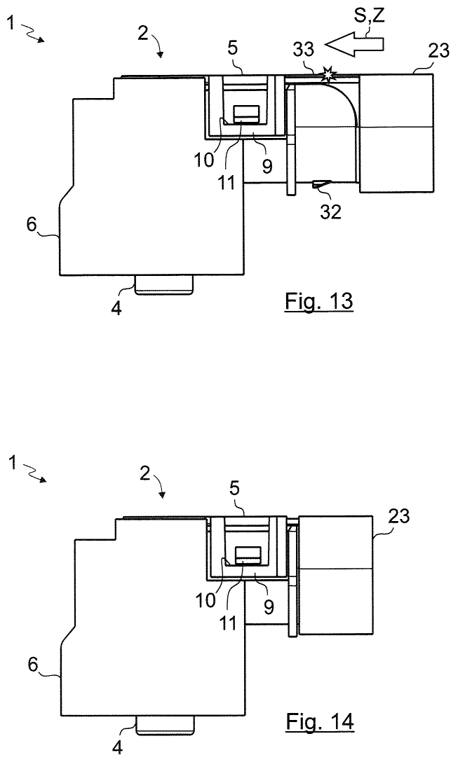

FIG. 13 shows the plug connector of FIG. 11 in a side view, during a third assembly step;

FIG. 14 shows the plug connector of FIG. 11 in a side view, in a fully assembled state of the housing assembly;

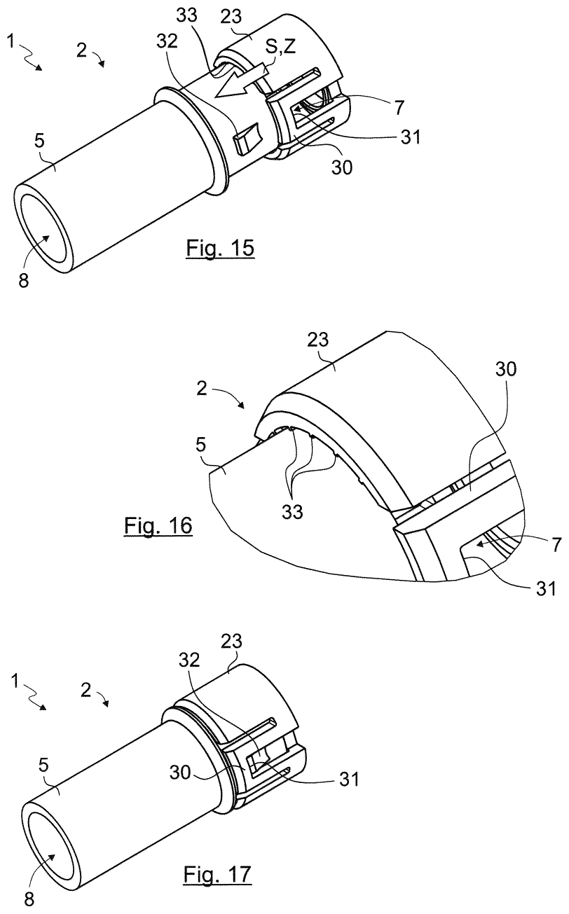

FIG. 15 shows a plug connector with a housing assembly according to a further exemplary embodiment of the invention in a perspective representation, during assembly;

FIG. 16 shows a cut-out enlargement of FIG. 15; and

FIG. 17 shows the plug connector of FIG. 15 in a perspective representation, in the assembled state.

In FIGS. 1 to 5, a plug connector 1 (for example, an electrical plug connector) with a housing assembly 2 and a cable 3 (for example, an electrical cable) opening into the housing assembly 2 is shown by way of example in several assembly steps of the housing assembly 2. The exemplary embodiments each show an angled plug connector, which, however, is not to be understood as restricting the invention. In principle, the invention is also suitable for use with non-angled plug connectors.

The plug connector 1 represented by way of example in FIGS. 1 to 5 can have various known plug connector components. By way of example, a contact element 4 is indicated in the figures (e.g. an outer conductor contact element or an inner conductor contact element).

The housing assembly 2 has at least a first housing part 5. In principle, this can already be sufficient within the scope of the invention, which will be clarified below using the exemplary embodiment of FIGS. 15 to 17. In the exemplary embodiments of FIGS. 1 to 14, however, the housing assembly 2 also has a second housing part 6. The first housing part 5 and the second housing part 6 can be mechanically connected to one another, as indicated in FIGS. 1 and 2.

In FIGS. 3 to 5, the housing parts 5, 6 are already connected to one another, and in their connected state they together form a cable bushing 7 through which the cable 3 can be introduced into an interior 6 (cf. FIG. 1) of the housing assembly 2 or of the plug connector 1. The housing parts 5, 6 form respective circumferential portions U₁, U₂ (cf. FIGS. 1 and 8) of the cable bushing 7 for this purpose.

The two housing parts 5, 6 can be locked together. For this purpose, the first housing part 5 has at least one at least in portions spring-elastic locking arm 9 with a locking receptacle 10, which can be gripped behind by a corresponding locking hook 11 of the second housing part 6 (cf., for example, the assembled state in FIG. 3). In principle, the connection between the first housing part 5 and the second housing part 6 can, however, also be fixed in another way, for example, by a screw connection, a frictional connection or even by a material connection.

A cable sealing element 12 (cf. FIGS. 6 to 10) for the cable 3 is accommodated in the cable 35 bushing 7 formed by the two housing parts 5, 6 in order to form a seal between the cable sheath 13 and the inner lateral surface 14 of the housing parts 5, 6 that form the cable bushing 7 (cf. FIG. 1).

In the exemplary embodiments, the cable sealing element 12 is by way of example formed in one piece together with a housing sealing element 15 by a common sealing body 16, which is shown in an individual representation in FIGS. 6 and 7 in a variant that is only to be understood as an example. In principle, a multi-part configuration and therefore a separate cable sealing element 12 is also possible.

The cable sealing element 12 is primarily formed to be tubular or sleeve-shaped, wherein the outer lateral surface 17 of the cable sealing element 12 preferably extends over the entire surface along the inner lateral surface 14 of the housing parts 5, 6 in the region of the cable bushing 7 when the housing assembly 2 is fully assembled. The cable sealing element 12 is formed to be completely closed or annular in the circumferential direction and has a central opening 18 (cf. FIG. 6) for the cable 3 to pass through.

The above-mentioned housing sealing element 15 is formed to ensure a seal between the housing parts 5, 6 and also forms a circumferentially closed profile with a further central opening 19 (cf. FIG. 6). The housing sealing element 15 is—like the housing parts 5, 6—formed to be angled, so that a first portion 20 of the housing sealing element 15 (a “U-shaped” portion) or a first portion 20 of the central opening 19 extends in a first plane E₁ and a second portion 21 (again “U-shaped” portion) of the housing sealing element 15 or a second portion 21 of the central opening 19 extends in a second plane E₂, as indicated in FIG. 7. The planes E₁, E₂ are preferably arranged orthogonally to one another, as can be clearly seen, for example, on the basis of FIGS. 2 and 7. A transition portion 22 can be provided between the two portions 20, 21 in order to enable a uniform and gentle, for example rounded, transition between the two portions 20, 21.

The seal body 16 or the housing sealing element 15 and/or the cable sealing element 12 can be fixed in at least one of the housing parts 5, 6, in particular connected in a materially bonded manner to one of the housing parts 5, 6. For example, the seal body 16 or the housing sealing element 15 can already be inject-molded in the first housing part 5 during production. In this way, manufacturing costs can be reduced and the assembly process can be simplified.

The proposed housing assembly 2 furthermore has a housing securing part 23 which at least in portions encloses the housing parts 5, 6 at least in the region of the cable bushing 7 and in particular in the region of the cable sealing element 12 in order to fix the housing parts 5, 6 to one another.

The housing securing part 23 can be displaceable at least on one of the housing parts 5, 6 into a final assembly position (cf. FIGS. 4 and 5). This displacement preferably takes place along a feed direction Z for the cable (cf. FIGS. 1 and 3), but can also deviate from the feed direction Z of the cable 3 if necessary. In the final assembly position, the housing securing part 23 fixes the housing parts 5, 6 together and thus increases the mechanical stability of the housing assembly 2 against transverse loads in the region of the cable bushing 7, so that the impermeability is maintained even under adverse conditions of use.

The housing assembly direction G (cf. FIG. 2) for connecting the first housing part 5 to the second housing part 6 and the securing assembly direction S (cf. FIG. 3) for assembling the housing securing part 23 on the housing parts 5, 6 preferably differ from one another. Particularly preferably, the housing assembly direction G and the securing assembly direction S run orthogonally to one another. However, this is not absolutely necessary—the securing assembly direction S can also possibly run in the same direction as the housing assembly direction G—in particular if the housing securing part 23 is not completely closed in the circumferential direction.

For the displacement of the housing securing part 23 on the at least one housing part 5, 6, a guide, in particular a linear guide, can be provided, particularly in the region of the housing parts 5, 6 in which the cable bushing 7 is formed. In particular, the guiding functions for the assembly of the housing securing part 23 and the fixing function of the housing securing part 23 can complement each other.

FIGS. 8 to 10 represent three exemplary variants of housing securing parts 23 based on a front view of the cable bushing 7 in an assembled state.

A particularly robust stabilization of the cable bushing 7 can be achieved, for example, if the housing securing part 23 fully circumferentially encloses the housing parts 5, 6 in the region of the cable bushing 7, as indicated in FIG. 8. Due to the corresponding interaction of the inner lateral surface of the housing securing part 23 and the outer lateral surface of the housing parts 5, 6 (particularly in the region of the cable bushing 7), a linear guide can thus also be provided.

The situation is similar with the housing securing part 23 according to FIG. 9, which only clasps the housing parts 5, 6 in the region of the cable bushing 7. For this purpose, a support surface 24 of the housing securing part 23 rests on a counter-support surface 25 of the housing parts 5, 6 forming the cable bushing 7. Starting from the support surface 24 of the housing securing part 23, two opposite side legs 26 extend, which clasp the second housing part 6 with their end portions. In turn, a linear guide can be formed at the same time as a result. 27 on both sides are formed. Correspondingly, the side legs 26 have elongated webs 28 which run in the securing assembly direction S and which are guided in corresponding grooves 29 of the housing parts 5, 6.

In its assembled state, the housing securing part 23 can be captively connected to at least one of the housing parts 5, 6. In the exemplary embodiments, the housing securing part 23 can be locked with the first housing part 5 and with the second housing part 6. For this purpose, the housing securing part 23 has an at least partially elastic locking arm 30 with a locking receptacle 31 (cf. FIG. 1), which can be gripped behind by a locking hook 32 of the respective housing part 5, 6 (cf. FIGS. 1 and 2). In principle, fixation between the housing securing part 23 and at least one of the housing parts 5, 6 can take place in any desired way, for example, also by pressing or screwing (not represented).

In the context of a method for assembling the electrical connector 1, it can, for example, first be provided that the cable 3 is passed through the housing securing part 23 and the cable sealing element 12 (=preassembly of the housing securing part 23 and the cable sealing element 12 on the cable 3). The housing securing part 23 can then be assembled so that at least the first housing part 5 is at least partially enclosed at least in the region of the cable bushing 7. In so far as two (or even more) housing parts 5, 6 are provided, these can optionally be connected or assembled to one another before the housing securing part 23 is assembled, so that the housing parts 5, 6 form respective circumferential portions U₁, U₂ of the common cable bushing 7 through which the cable 3 is guided into the interior 8 of the plug connector 1.

In order to further improve the production of the housing assembly 2 and the assembly of the housing assembly 2, it can optionally be provided that at least one of the housing parts 5, 6 (in the exemplary embodiments, in each case the first housing part 5) and the housing securing part 23 are, in a pre-assembly state or in a unassembled state, connected to one another in one piece via at least one connecting web 33. The principle should first be explained in greater detail on the basis of the exemplary embodiment of FIGS. 11 to 14.

FIGS. 11 to 14 show a fundamentally similar exemplary embodiment of the invention, as already explained on the basis of FIGS. 1 to 10, which is why functionally identical elements are not described again in detail. The cable 3 and the cable sealing element 12 or the sealing body 16 are hidden in FIGS. 11 to 14. Again, the housing assembly 2 has a first housing part 5 and a second housing part 6, which in the assembled state together form a cable bushing 7 in which a cable sealing element 12 for the cable 3 is accommodated.

For the one-piece connection between the first housing part 5 and the housing securing part 23, a connecting web 33 is provided, which is formed in the manner of a film hinge. For this purpose, the connecting web 33 has, at least in portions, a very thin wall thickness and is therefore sufficiently elastic to enable a pivoting movement between the housing securing part 32 and the first housing part 5. The end position of the housing securing part 32 on the first housing part 5 can possibly already be reached by this pivoting movement. If necessary, it can, however, also be provided that the connecting web 33 breaks off in a defined manner during the pivoting movement and/or during a subsequent axial movement. The connecting web 33 can therefore also be formed as a predetermined breaking point.

Through this connecting web 33, the first housing part 5 and the housing securing part 23 can be produced together during assembly, in particular by a common plastic injection molding process, wherein the first housing part 5 and the housing securing part 23, before or during final assembly, can be separated by breaking the predetermined breaking point or can be assembled together by a movement guided over the connecting web 33. The housing securing part 23 and the housing parts 5, 6 are therefore preferably formed from the same material, in particular a plastic.

After assembly of the two housing parts 5, 6 (cf. FIGS. 11 and 12), it can therefore be provided, for example, that the housing securing part 23, which in the exemplary embodiment of FIGS. 11 and 14 in the pre-assembled state retained via the connecting web 33 is retained in rotated or pivoted and axially (along the feed direction Z for the cable 3) in comparison with the final assembly position, is first pivoted (cf. FIGS. 12 and 13) and then displaced along the securing assembly direction S to the final assembly position (cf. FIGS. 13 and 14). The connecting web 33 can optionally be formed to break at any time during the assembly process, in particular during the axial displacement along the securing assembly direction S (indicated in FIG. 13).

In the exemplary embodiment of FIGS. 11 to 13, exactly one connecting web 33 is provided for connecting the housing securing part 23 to the first housing part 5. In principle, however, several connecting webs 33 can also be provided, for example, several connecting webs 33, which are distributed circumferentially along the circumference of the cable bushing 7 and, for example, equidistantly, as indicated in FIGS. 1 to 5 and in particular in FIGS. 3 to 10. When using several connecting webs 33 distributed along the circumference of the cable bushing 7, it can preferably be provided that the housing securing part 23 is only offset axially along the feed direction Z or securing assembly direction S compared to the final assembly state, but is not twisted or pivoted.

As already mentioned, within the scope of the invention, it is not absolutely necessary that the connecting web 33 breaks off during assembly. In principle, the connecting web 33 can also be formed to be sufficiently elastic or deformable in order to enable the housing securing part 23 to move into the final assembly position without breaking off. However, this is less preferred.

As also already mentioned, it is advantageous within the scope of the invention, but not absolutely necessary, for the housing assembly 2 to have a plurality of housing parts 5, 6. In principle, the first housing part 5 can already be sufficient, the outer wall of which can then be mechanically reinforced by means of the housing securing part 23. A corresponding exemplary embodiment, in which the plug connector 1 or the housing assembly 2 only has a single housing part 5, is shown by way of example in FIGS. 15 to 17. The cable 3 and the cable sealing element 12 or the sealing body 16 are also hidden in FIGS. 15 to 17 to simplify the illustration.

FIGS. 15 to 17 each show a cut-out of a coaxial plug connector 1, wherein the specific geometric design and the plug type are not important within the scope of the invention. The exemplary, round plug connector 1 has the first housing part 5, along the outer sheath of which the housing securing part 23 can be displaced linearly along the feed direction Z for the cable 3, not represented.

As can be seen in particular on the basis of the cut-out enlargement of FIG. 16, the first housing part 5 and the housing securing part 23 are connected to one another in one piece in the preassembly state shown in FIGS. 15 and 15 via several connecting webs 33 arranged distributed along the circumference (a single connecting web 33 may, however, already be sufficient, as mentioned above). These connecting webs 33 are formed as predetermined breaking points and break off in a defined manner due to the axial displacement of the housing securing part 23 in the direction of the final assembly position. In the final assembly position shown in FIG. 16, the first housing part 5 and the housing securing part 23 are locked together (cf. locking arm 30 or looking receptacle 31 of the housing securing part 23 and locking hook 32 of the first housing part 5).

1. A housing assembly (2) for a plug connector (1), the housing assembly (2) comprising:
a first housing part (5), that forms at least a circumferential portion of a cable bushing (7) through which a cable (3) can be introduced into an interior (8) defined by the housing assembly (2); and
a cable sealing element (12), for the cable (3) in the cable bushing (7); and
a housing securing part (23) which, at least in portions, encloses the first housing part (5) proximate the cable bushing (7), in a region of the cable sealing element (12); and
a connecting web (33), that connects the first housing part (5) and the housing securing part (23) to one another in a pre-assembly state.

2. The housing assembly (2) as claimed in claim 1 and wherein, the connecting web (33) is a predetermined breaking point to separate the first housing part (5) and the housing securing part (23) from one another.

3. The housing assembly (2) as claimed in claim 1 and wherein, the connecting web (33) is elastically deformable at least in portions, to enable assembly of the housing securing part (23) on the first housing part (5).

4. The housing assembly (2) as claimed in claim 1 and wherein, the connecting web (33) is proximate the cable bushing (7) formed by the first housing part (5).

5. The housing assembly (2) as claimed in claim 1 and further comprising:
plural connecting webs; and
the plural connecting webs (33) are spacedly arrayed about a circumference of the cable bushing (7).

6. The housing assembly (2) aa claimed in claim 1 and wherein, precisely one connecting web (33) is provided.

7. The housing assembly (2) as claimed in claim 1 and wherein, the housing securing part (23) is, in the preassembly state, rotated or pivoted relative to an assembled state of the housing securing part (23) on the first housing part (5).

8. The housing assembly (2) as claimed in claim 1 and wherein, the housing securing part (23) is, in the preassembly state, spaced apart from the cable bushing (7) along a feed direction (Z) for cable (3) in comparison to an assembled state of the housing securing part (23) on the first housing part (5) along a feed direction (Z) for the cable (3).

9. The housing assembly (2) as claimed in claim 1 and further comprising:
a second housing part (6); and
the first housing part (5) and the second housing part (6) when connected to one another, each form circumferential portions (U₁, U₂) of the cable bushing (7); and wherein
the housing securing part (23 encloses at least a portion of each of the first housing part (5) and the second housing part (6) in the region of the cable bushing (7) in order to fix the first and second housing parts (5, 6) to one another.

10. The housing assembly (2) as claimed in claim 9 and wherein, a housing assembly direction (G) for connecting the first housing part (5) to the second housing part (6); and
a securing assembly direction (S) for assembling the housing securing part (23) on the first and the second housing parts (5, 6) are not the same.

11. The housing assembly (2) as claimed in claim 1 and wherein, the housing securing part (23) is displaceable along a feed direction (Z) into a final assembly position in which the housing securing part (23) encloses at least a portion of the first housing part (5) proximate the cable bushing (7); and wherein
the housing securing part (23) and the first housing part (5) together form a linear guide.

12. The housing assembly (2) as claimed in claim 9 and wherein, the housing securing part (23) circumferentially encloses the first housing part (5), and the second housing part (6), in a region of the cable bushing (7).

13. The housing assembly (2) as claimed in claim and further comprising:
a housing sealing element (15) that has a circumferentially closed profile and which defines a central opening (19); and
the housing sealing element (15) provides a seal between the first housing part (5) and a second housing part (6); and wherein
the housing sealing element (15) is formed at an angle so that a first portion (20) of the housing sealing element (15) and the central opening (19) defined by the housing sealing element (15) extend in a first plane (E₁); and
a second portion (21) of the housing sealing element (15) and the central opening (19) defined by the housing sealing element (15) extend in a second plane (E₂).

14. A plug connector (1) comprising:
a housing assembly (2) having,
a first housing part (5), that forms at least a circumferential portion of a cable bushing (7) through which a cable (3) can be introduced into an interior (8) defined by the housing assembly (2), and
a cable sealing element (12), for the cable (3) in the cable bushing (7), and
a housing securing part (23) which, at least in portions, encloses the first housing part (5) proximate the cable bushing (7), in a region of the cable sealing element (12), and
a connecting web (33), that connects the first housing part (5) and the housing securing part (23) to one another in a pre-assembly state; and a contact element (4) which can be connected to the cable (3).

15. A method for assembling a plug connector (1), comprising the steps:
providing a housing assembly (2), the housing assembly (2) having
a first housing part (5), that forms at least a circumferential portion of a cable bushing (7), and
a housing securing part (23), and
a connecting web (33) that connects the housing securing part (23) and the first housing part (5) to one another in a preassembly state; and
providing a cable (3) and introducing the cable (3) through a cable sealing element (12) which is accommodated in the cable bushing (7); and
connecting the housing securing part (23) on the first housing part (5) so that the first housing part (5) is enclosed at least in portions proximate the cable bushing (7) by the housing securing part (23); and
breaking the connecting web (33) to separate the first housing part (5) from the housing securing part (23) prior to or during assembly of the plug connector (1).

16. The housing assembly (2) as claimed in claim 9 and further comprising:
a housing assembly direction (G) for connecting the first housing part (5) to the second housing part (6); and
a securing assembly direction (S) for assembling the housing securing part (23) on the first and the second housing parts (5, 6); and
the housing assembly direction (G) and the securing assembly direction (S) run orthogonally to one another.

17. The housing assembly (2) as claimed in claim 1 and wherein, the connecting web (33) is elastically deformable as a hinge to enable assembly of the housing securing part (23) on the first housing part (5).
